(19) United States
(12) Patent Application Publication
(10) Pub. No.: US 2015/0121820 A1
(43) Pub. Date: May 7, 2015

(54) SADDLE PAD AND METHOD

(71) Applicant: Carlee S. Mahajan, Grafton, OH (US)

(72) Inventor: Carlee S. Mahajan, Grafton, OH (US)

(21) Appl. No.: 14/529,892

(22) Filed: Oct. 31, 2014

Related U.S. Application Data
(60) Provisional application No. 61/898,945, filed on Nov. 1, 2013.

(51) Int. Cl. B68C 1/12; D03D 1/00

(52) U.S. Cl. CPC B68C 1/12; D03D 1/00
USPC 54/66; 28/158

(57) ABSTRACT

Various embodiments of a saddle pad are disclosed. In one example, the saddle pad a includes, by weight, from about 70% to about 95% by weight animal fiber of at least one of the Camelidae Family and the Bovidae Family and from about 5% to about 30% of an alternative fiber material.

### RELATED APPLICATION

This patent application claims priority to Application Ser. No. 61/898,945 entitled “Saddle Pad and Method” filed on Nov. 1, 2013 and which is incorporated by reference herein.

### TECHNICAL FIELD

The present invention relates generally to pads for use on a riding or pack-bearing animal and the method of making the pad. More specifically, the present invention relates to a saddle pad for placement between a saddle and an animal, for example a horse and the method for making the saddle pad.

### BACKGROUND

Saddle pads are used to protect an animal from injury or discomfort from the weight of the saddle, a rider, or cargo. For example, equine saddle pads are placed between the saddle and a horse to cushion the horse from the load, prevent slippage, and alleviate an abrading friction on the horse's back.

Saddle pads are found in a variety of constructions and materials. Materials that have been used include natural fibers, for example, wool and cotton, synthetic fibers such as polyester, polyurethanes, polyvinylacetate (EVA) polymers, and blends thereof. Various problems are encountered with conventional saddle pads depending on its construction. For example, some pads retain moisture and become heavy which increases the load and traps heat generated by the horse. Other pads become easily soiled with the perspiration of the horse which breeds bacteria and diseases. As a result the pad becomes odorous and can also break down and lose its cushioning properties. Still other pad constructions grab and pinch the hairs on the horse's back or rubs abrasively the muscles of the horse which causes greater discomfort or injury. All of the problems associated with conventional saddle pads not only negatively impacts the comfort of the horse but also inhibits the movement of the horse. Therefore, there is need for pads that provides greater comfort, durability, ventilation and moisture control.

### SUMMARY

Several embodiments of a saddle pad are disclosed. In one embodiment of the present invention the saddle pad comprises a single, unitary layer comprising from about 70% to about 95% by weight animal fiber of at least one of the Camelidae Family and the Bovidae Family, and 5% to about 30% by weight an alternative material. An alternative fiber includes natural fiber, synthetic fibers, and mixtures thereof.

In another embodiment a saddle pad herein is a two-layer pad that includes a first layer and a second layer, and the first layer and second layer have two different material compositions. The first layer comprises from about 70% to about 95% by weight animal fiber of the Camelidae Family or the Bovidae Family, and from about 5% to about 30% by weight of an alternative material, based on the weight of the first layer. The second layer comprises from about 50% by weight to about 95% by weight animal fiber of at least one of the Camelidae Family and the Bovidae Family, and up to about 50% by weight an alternative material. In another embodiment the first layer comprises from about 70% to about 95% by weight alpaca fiber and from about 5% to about 30% of an alternative fabric material.

In another embodiment of the present invention, the saddle pad is a three-layer pad that includes a first layer, a second layer and a third layer disposed between the first and second layer. The third layer or “middle layer” is a weave construction comprising a plurality of yarns that form a criss-cross pattern. In one embodiment the yarns of the third-layer weave of core-spun yarn.

In yet another embodiment, a method for making the three-layer saddle pad includes weaving yarns to form a third layer or “middle layer”; attaching the middle layer to either the first layer or the second layer; and attaching the second layer to the first layer.

### BRIEF DESCRIPTION OF THE DRAWINGS

The various embodiments of the present invention can be understood with reference to the following drawings. The components in the drawings are not necessarily to scale. Also, in the drawings, like reference numerals designate corresponding parts throughout the several views.

FIG. 1 is a side schematic view of a horse having a saddle and saddle pad, according to an embodiment of the present invention;

FIG. 2 is a perspective, expanded view schematic of a two-layer saddle pad, according to an embodiment of the present invention;

FIG. 3 is an exploded schematic view of a three-layer saddle pad, according to an embodiment of the present invention;

FIG. 4 is a perspective view of a yarn section of the middle-layer of the three-layer saddle pad of FIG. 3, according to an embodiment of the present invention;

FIG. 5 is a perspective schematic view of the three-layer saddle pad of FIGS. 3 and 4 showing the attachment of middle-layer to the first layer or animal-side layer, according to an embodiment of the present invention;

FIG. 6 is a top schematic view of the middle-layer attached to the first layer of the three-layer saddle pad of FIG. 5, according to an embodiment of the present invention;

FIG. 7 is a perspective view of the three-layer saddle pad of FIG. 5 showing attachment of the second layer to the middle layer and first layer of the pad, according to an embodiment of the present invention;

FIG. 8 is a top view of the three-layer saddle pad of FIG. 7 taken along lines 8-8, and showing the second layer attached to the first layer with the middle-layer shown in phantom, according to an embodiment of the present invention; and

FIG. 9 is a cross-sectional illustration of the saddle pad of FIG. 8 taken along lines 9-9, and showing the detail of the attachment of the middle layer, according to an embodiment of the present invention.

### DETAILED DESCRIPTION

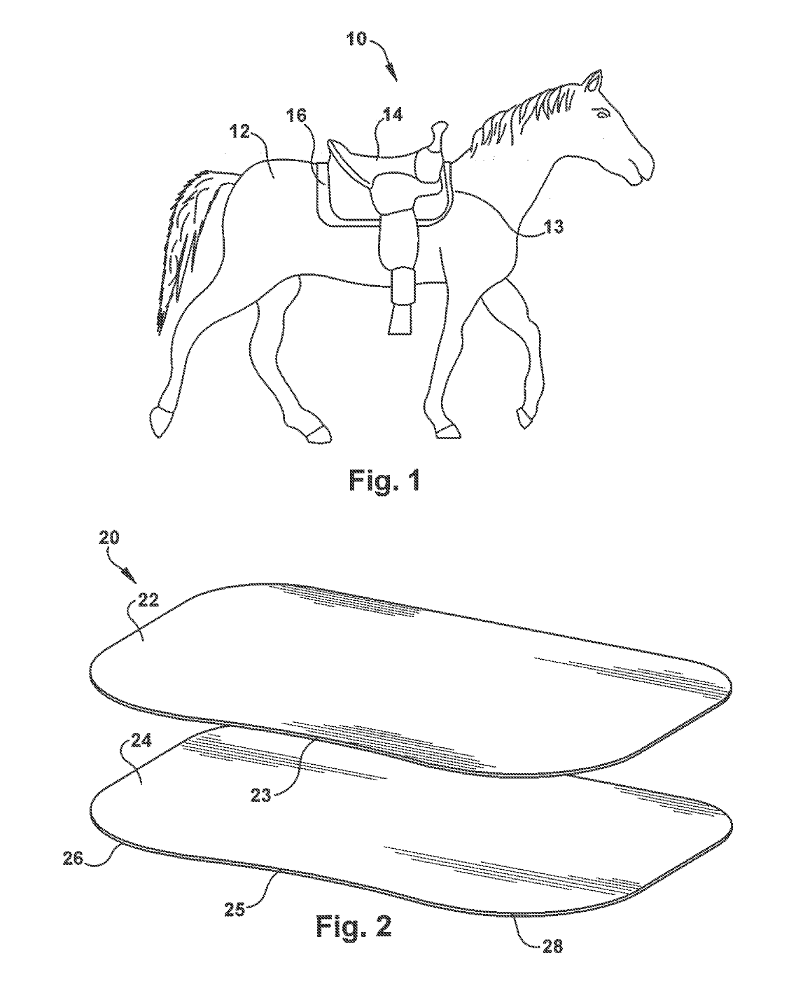

Various embodiments of a saddle pad having combined features that provide durability, cushioning, ventilation and moisture resistance, are disclosed herein. The discussion with reference to the FIG. 1 through FIG. 9 refer to an equine saddle pad, however, it should be understood that the saddle pads may be used for any riding or pack-bearing animal.

The various embodiments of the saddle pad herein are made of materials that include at least one of animal fiber of the Camelidae Family of animals, the Bovidae Family of animals, and an alternative fiber material. An “alternative fiber material” is herein defined as any natural fiber, synthetic fiber, or blends thereof, other than, or different than, the animal fiber of the Camelidae Family and the Bovidae Family of animals. Natural fibers, include but are not limited to, plant fibers, animal fibers, and any fiber of nature, for example wool and cotton. Synthetic fibers include, but are not limited to, thermoplastics and thermosets, and blends thereof, for example polyester fiber, nylon fiber, polyurethane fiber, ethyvinylacetate (EVA), and blends thereof.

The animal fiber of the Camelidae Family of animals includes, but is not limited to, alpaca fiber, llama fiber, vicuana fiber, and camel fiber, for example. The animal fiber of the Bovidae includes, but is not limited to the American bison fiber and yak fiber, for example.

FIG. 1 illustrates a side view of a fitted riding horse 10 that includes horse 12, saddle 14, and saddle pad 16. Saddle 12 is a “Western” style saddle, however, other styles, for example the “English” style saddle could also be used. In one embodiment of the present invention the saddle pad comprises a single, unitary layer comprising, by weight, based on the weight of the pad: from about 70% to about 95%, in another embodiment from about 80% to about 90%, and in another embodiment from about 75% to about 85% animal fiber of the at least one of the Camelidae Family and the Bovidae Family. Such animal fiber from the Camelidae Family includes, but is not limited to, alpaca fiber, llama fiber, and vicuana fiber. Animal fiber from the Bovidae Family includes, but is not limited to, yak fiber and buffalo fiber. The animal fiber preferably has a denier that ranges from about 20 to about 40 microns, and in another embodiment, from about 25 to about 30 microns. The animal fiber of the Camelidae Family and Bovidae Families of animals are soft to the touch relative to conventional saddle pad fiber materials.

Saddle pad 16 also includes, by weight, from about 5% to about 30%, in another embodiment from about 10% to about 20%, and in yet another embodiment from about 15% to about 25% alternative fiber material, based on the weight of the saddle pad. The alternative fiber material provides memory and elasticity to the saddle pad, and the combination of materials in saddle pad 16 provide softness and moisture resistance while also maintaining overall pad stability and shape.

In another embodiment, the alternative fiber material of saddle pad 16 includes from about 5% to about 50%, in another embodiment from about 5% to about 25% and in another embodiment from about 7% to about 13% by weight bamboo fiber based on the weight of the saddle pad. Bamboo fiber combined with the animal fiber of the Camelidae Family and the Bovidae Family of animals described above, further improves the memory and stability of the pad. In another embodiment of the present invention, the bamboo fiber is carbonized. The carbonized bamboo fiber can minimize or prevent fungus buildup from bacteria that is originates from a soiled pad, perspiration of the horse, from the environment, etc.

Accordingly, in an example embodiment, saddle pad 16 comprises, by weight, from about 70% to about 95% alpaca, from about 5% to about 30% carbonized bamboo, based on the weight of the saddle pad. The animal fibers of the Camelidae Family and Bovidae Family of animals, are soft against the horse and minimize the “grabbing” of the horse hair which is typical of conventional wool saddle pads for example.

The unitary or single layer saddle pad 16, according to the various embodiments described above, can be made via the needle-felted or wet-felted processes. For example the animal hair of the Camelidae Family and/or the Bovidae Family of animals, for example, alpaca, along with the alternative fiber material, for example, bamboo or carbonized bamboo, can be blended and put through the felted processes to produce the layer of saddle pad 16. The thickness of saddle pad 16 can vary and typically ranges from about 0.1 inch to about 4 inches, in another embodiment, from about 0.25 inch to about 2 inches, and in another embodiment from about 0.5 inch to about 1.5 inches.

FIG. 2 is a perspective, expanded view illustration of a two-layer saddle pad 20, according to an embodiment of the present invention. In one embodiment the first layer 24 and second layer 22 have two different material compositions, however, it is also possible that the two layers have the same composition. Saddle pad 20 includes a first layer 24, or “horse-side” layer, and a second layer 22, or “rider-side layer.”

First layer 24 of two-layer saddle pad 20 can include, for example, any of the material embodiments of saddle pad 16 described above with respect to FIG. 1. Second layer 22 can include by weight, from about 50% to about 100%, in another embodiment from about 50% to about 95%, and in yet another embodiment from about 70% to about 95% animal fiber of the Camelidae Family and the Bovidae Family of animals, based on the weight of the second layer. Second layer 22 also includes, by weight, up to about 50%, in another embodiment from about 5% to about 50%, and in yet another embodiment, from about 10% to about 30% alternative fiber material, based on the weight of the second layer. Examples of alternative fiber material include those listed above with respect to saddle pad 16.

The material composition of first layer 24 and second layer 22 can also be based on the total weight of saddle pad 20. Accordingly, saddle pad 20 can include by weight, from about 60% to about 97%, in another embodiment from about 65% to about 93%, and in yet another embodiment from about 72% to about 87% animal fiber of the Camelidae Family and the Bovidae Family of animals, based on the weight of the saddle pad 20. Saddle pad 20 also includes, by weight, from about 3% up to about 40%, in another embodiment from about 7% to about 35%, and in yet another embodiment, from about 13% to about 28% alternative fiber material, based on the weight of the saddle pad.

In another embodiment of saddle pad 20, the first layer 24 and the second layer 22 have the same material composition, and in another embodiment the first layer 24 and second layer 22 have different material compositions.

Layers 22 and 24 of two-layer saddle pad 20 may optionally include inwardly concave edge portions 23 and 25, respectively to conform to the back of the horse, for example around the withers of the horse. Extended portions 26 and 28 of saddle pad 20 cover the shoulders of the horse. The thickness of saddle pad 20 can vary and typically ranges from about 0.1 inch to about 4 inches, in another embodiment, from about 0.25 inch to about 2 inches, and in another embodiment from about 0.5 inch to about 1.5 inches.

In an example embodiment, two-layer saddle pad 20 has a first layer 24 and a second layer 22 that include alpaca fiber as the animal fiber of the Camelidae Family and the Bovidae Family of animals, and at least one of bamboo, carbonized bamboo and wool, i.e. as blends thereof, as the alternative fiber material in accordance with the various compositions described above for saddle pad 20.

Two-layer saddle pad 20 can be made by attaching the first layer 24 and the second layer 22 via one or more of several means. For example, the layers 22 and 24 may be bonded by adhesive, for example, a liquid adhesive, or a hot melt adhesive. Layers 22 and 24 can also be sewn or stitched together via fibers, for example with a nylon or polyester thread, for example. The thickness of two-layer saddle pad 20 can vary and typically ranges from about 0.1 inch to about 4 inches, in another embodiment, from about 0.25 inch to about 2 inches, and in another embodiment from about 0.5 inch to about 1.5 inches.

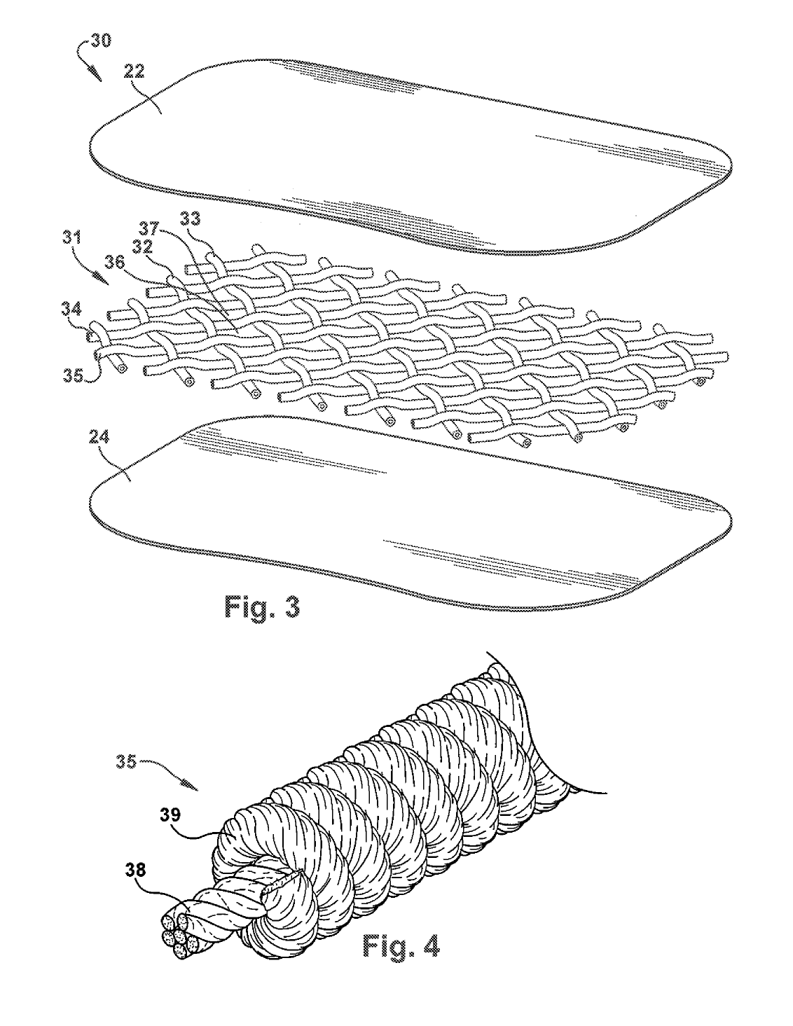

FIG. 3 is an exploded view of a three-layer saddle pad 30, according to another embodiment of the present invention. Three-layer saddle pad includes a first layer 24, a second layer 22, and a third layer 32, or “middle layer,” disposed between the first and second layers. The middle layer is a weave construction comprising a plurality of yarns that are oriented in a criss-cross pattern of intersecting straight lines or paths.

Third layer 32 includes a plurality of parallel yarns 32, 33, that intersect at a substantially perpendicular angle with a plurality of parallel yarns 34, 35 in an alternating weave. More specifically, FIG. 3 shows yarn 32 intersects with yarn 34 and 35 by weaving over yarn 34 and under yarn 35, whereas yarn 33 which is adjacent to yarn 32 intersects with yarn 34 and 35 in an opposite fashion by weaving under yarn 34 and over yarn 35. The weave pattern is generally loose with the third layer 32 having a plurality of openings 36, 37, between the yarns. The distance between parallel yarns of “middle layer” 32, for example yarns 32 and 33, can range from about ⅛ inch to about 5 inches, in another embodiment from about ¼ inch to about 4 inches, in another embodiment from about 0.5 inch to about 3 inches, and in yet another embodiment from about 1 inch to about 2 inches. The parallel yarns of the are shown in FIG. 3 as oriented at an angle relative to the edges of first layer 24 and second layer 22, although they could be parallel to the edges.

FIG. 4 is a perspective view of yarn 35 of the middle-layer 32 which includes core 38 and fiber bundle 39 disposed on the surface of the core. Core 38 provides wicking function to the outer extremities of saddle pad 30 to maintain low moisture content in the pad. Core 38 may be made of several materials that exhibit good absorbing and wicking properties. In one embodiment, the core 38 is made of a material that absorbs at least about 20% of its weight, in another embodiment from about 20% to about 40% of its weight, and in another embodiment, from about 30% to about 40% of its weight at saturation. For example, if the absorbent wool core has weighs one pound dry, then it will weigh up to 1.38 pounds at saturation. Materials that have good absorbtion properties include, but are not limited to, wool, cotton, plant products, and blends thereof. The middle layer improves ventilation and wicking of moisture from the interior to the extremities of the pad.

Fiber bundle 39 of yarn 35 can be a bulky yarn bundle that is spun in a helical fashion about core 30 via a core spinning process. The twisted fiber bundle 39 is shown as a single-ply bundle, although two-ply and three-ply fiber bundles, for example a fiber bundle that is braided, can also be wrapped around core 30. The drafting twist of fiber bundle 39 can range from 2:1 to 10:1, in another embodiment from 5:1 to 8:1. Preferably, the denier of the fiber strands ranges from about 20 microns to about 40 microns, in another embodiment from about 25 microns to about 35 microns. In one embodiment fiber bundle 39 is made of a plurality of strands of animal fiber of at least one of the Camelidae and Bovidae Families of animals. In another embodiment the fiber bundle 39 is made of any absorbent material described above. In yet another embodiment the fiber bundle 39 can be a mixture of the absorbent fibers and the animal fibers of the Camelidae and Bovidae Families of animals, for example a mixture that comprises from about 50% to 100% by weight alpaca fiber and 50% to 100% absorbent fiber such as wool.

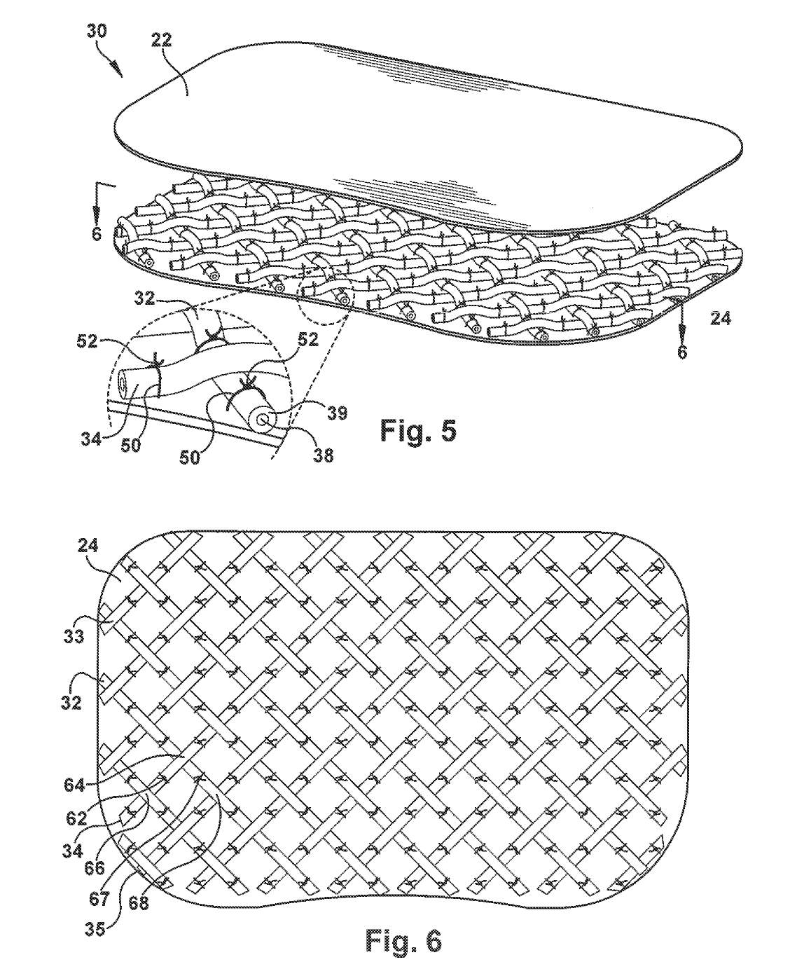

FIG. 5 is a perspective view of the three-layer saddle pad 30 showing yarns 33 and 34 of middle-layer 30 attached to first layer 24, or “animal-side” layer. The break-out view shows a close-up of stitching thread 50 that extends through first layer 24 and around circumference of yarns 32 and 34 to forms a knot 52 opposite the surface of first layer 24, according to one embodiment of the invention. In another embodiment thread 50 can extend through first layer 24 and yarns 32, for example. Alternatively, yarns of the middle-layer 30 can be attached to second layer 22, or “rider-side” layer, the yarns can be attached to both the first layer 24 and the second layer 22 of the saddle pad 30. When the yarns are attached to only one layer, for example the first layer 24 as shown in FIG. 5, there is increased freedom of movement of the first layer and second layer relative to one another. For example, the rider-side layer which is in contact with the saddle or the rider, and the horse-side layer which is in contact with the horse can move in natural movement of the saddle or rider. This can also help prevent the saddle from “walking” out from under the saddle.

FIG. 6 is a top view of the middle-layer 32 attached to first layer 24 of saddle pad 30 shown in FIGS. 3 and 5. As shown, each of the plurality of intersecting yarns 33, 34, of the third layer are attached to the first layer or the second layer at locations between intersecting yarns, i.e. in other words along the yarn that lies between the intersections of the criss-cross pattern. For example, as shown in FIG. 6, yarns of the middle layer are attached at site 62 which is along the yarn between intersections 64 and 66, and attached at site 67 which is between intersections 64 and 68. The attachment location can vary between intersections, although in one embodiment the attachment location is approximately halfway between intersections. The yarns are free to move with respect to one another at the intersections and provide fluffy areas for a pillowing the saddle pad.

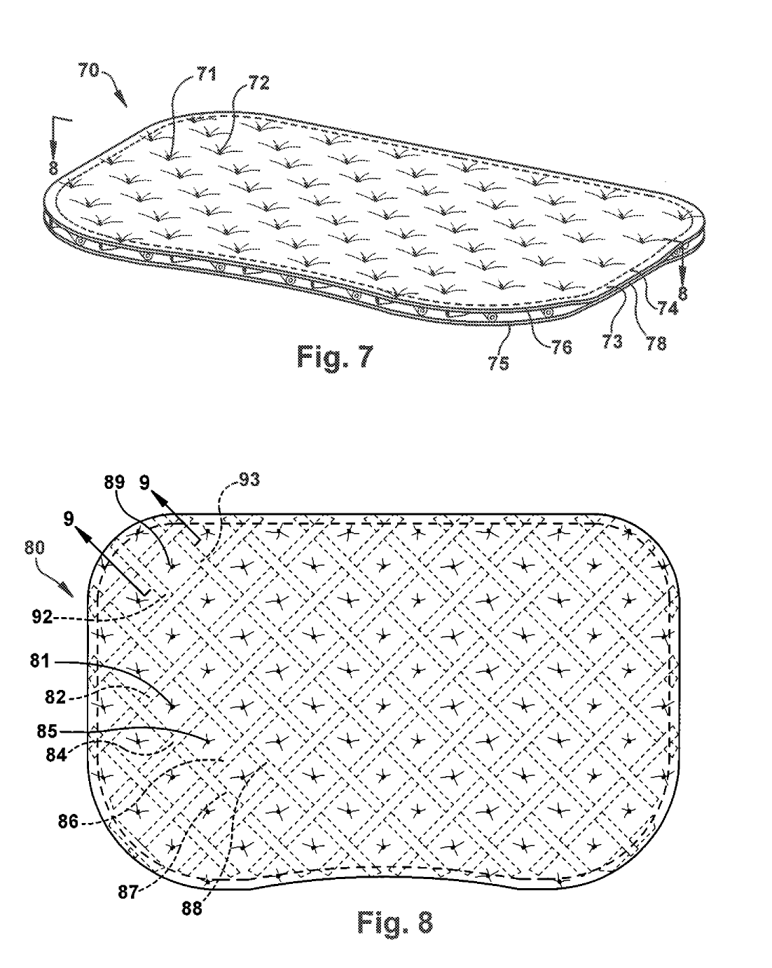

FIG. 7 is a perspective view of the three-layer saddle pad 70 showing the pillowing effect of the saddle pad once the second layer or “rider-side” layer is attached to first layer or “horse-side” layer. Attachment sites 71 and 72 create tufting throughout the saddle pad which provides cushioning for both the horse and the rider. A portion 73 of the saddle pad is shown fully assembled where hem stitching 73 and 74 attach all three layers. The stitching 73, 74, runs along the perimeter at a distance from the edges 75 and 76 of the first and second layers.

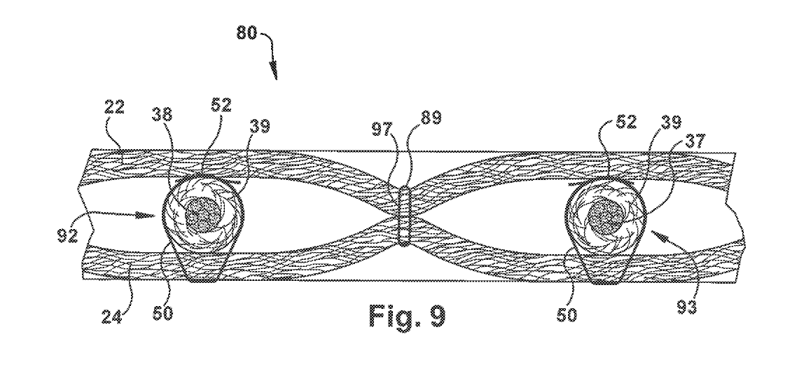

FIG. 8 is a top view of the three-layer saddle pad of FIG. 7 taken along lines 8-8, and the middle-layer shown in phantom. Tufting site 81 attaches the top layer to the bottom layer at a location between parallel yarns 82 and 84 and 87 and 88 of the middle layer, and tufting site 85 attaches the top layer to the bottom layer between parallel yarns 84 and 86 and between parallel yarns 87 and 88. FIG. 9 shows the cross-section of saddle pad of FIG. 8 taken along lines 9-9. Yarns 92 and 93 are disposed between first layer 24 and second layer 22. The third or middle layer is attached to first layer 24 by thread 50 which extends the circumference of the yarn. Thread 97 attaches first layer 24 to second layer 22 in a tight fashion and which creates a pillowing effect in the areas surrounding the yarn of the middle layer yarns that form the weave. The thicknesses of the individual layers of the pad and the overall pad can vary. For example, the first and second layers each range from about 0.25 inch to about 1.5 inches thick. The thickness of the three-layer pad ranges from about 0.25 inches to about 4 inches, in another embodiment, from about 0.25 inch to about 2 inches, and in another embodiment from about 0.5 inch to about 1.5 inches

It will be appreciated that the saddle pads produced in accordance with the embodiments of the present invention have a structure and composition that enhances life of and performance of saddle pads used for animals.

In yet another embodiment, a method for making the three-layer saddle pad includes weaving yarns to form a third layer or “middle layer”; attaching the middle layer to either the first layer or the second layer; and attaching the second layer to the first layer.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. A saddle pad comprising:
a first layer comprising, by weight, from about 70% to about 95% by weight animal fiber of at least one of the Camelidae Family and the Bovidae Family and from about 5% to about 30% of an alternative fiber material.

2. The saddle pad of claim 1, wherein the alternative fiber material is selected from the group of: synthetic fiber, plant fiber, and animal fiber other than animal fiber of the Camelidae Family and Bovidae Family, and combination thereof.

3. The saddle pad of claim 1, wherein the alternative fiber material comprises carbonized bamboo.

4. The saddle pad of claim 1, wherein the animal fiber comprises alpaca, and the alternative fiber material comprises wool and carbonized bamboo.

5. The saddle pad of claim 1, further comprising:
a second layer having a material composition that is different than the first layer.

6. The saddle pad of claim 5, wherein the second layer comprises:
from about 50% to about 100% by weight animal fiber of at least one of the Camelidae Family and the Bovidae Family; and
from about 0% to about 50% of an alternative fiber material

7. The saddle pad of claim 5, wherein:
the first layer comprises, by weight, from about 70% to about 95% alpaca and about 5% to about 30% alternative fiber material; and
by weight, from about 50% to about 100% alpaca and about 5% to about 50% alternative fiber material.

8. The saddle pad of claim 5 wherein:
the first layer comprises, by weight, from about 75% to about 85% alpaca.

9. The saddle pad of claim 8, wherein the second layer comprises, by weight, at least about 5% wool.

10. The saddle pad of claim 1, further comprising:
a second layer having a material composition that is different than the first layer; and
a third layer disposed between the first and the second layer, wherein the third layer is a weave fabric comprising a plurality of intersecting yarns.

11. The saddle pad of claim 10, wherein the first layer comprises bamboo.

12. The saddle pad of claim 10, wherein the first layer comprises carbonized bamboo.

13. The saddle pad of claim 10, wherein each of the plurality of intersecting yarns of the third layer comprise at least one fiber bundle wound around a core.

14. The saddle pad of claim 13, wherein the at least one fiber bundle comprises alpaca and the core comprises an absorbent material that absorbs at least about 20% of its weight upon saturation.

15. The saddle pad of claim 10, wherein:
the first layer comprises from about 5% to about 30% by weight carbonized bamboo and about 70% to about 95% by weight alpaca; and
each of the plurality of intersecting yarns of the third layer comprise at least one fiber bundle comprising alpaca and a core strand of wool.

16. A saddle pad comprising:
a first layer;
a second layer; and
a third layer disposed between the first layer and the second layer, wherein the third layer is a weave fabric comprising a plurality of intersecting yarns.

17. The saddle pad of claim 16, wherein each of the plurality of intersecting yarns of the third layer comprise a fiber bundle disposed around the surface of a core.

18. The saddle pad of claim 17, wherein first layer comprises alpaca.

19. The saddle pad of claim 17, wherein the first layer comprises alpaca fiber and bamboo fibers.

20. The saddle pad of claim 17, wherein the first layer comprises alpaca and carbonized bamboo fibers.

21. The saddle pad of claim 17, wherein each of the at least one fiber bundles disposed around the surface of the core comprises alpaca.

22. The saddle pad of claim 21, wherein the core strand comprises fiber of an absorbent material that absorbs at least about 20% of its weight upon saturation.

23. The saddle pad of claim 21, wherein the first layer comprises alpaca and an alternative fiber material.

24. The saddle pad of claim 23, wherein the first layer comprises bamboo.

25. The saddle pad of claim 24, wherein the first layer comprises carbonized bamboo.

26. The saddle pad of claim 16, wherein the third layer is attached to the first layer or the second layer.

27. The saddle pad of claim 17, wherein each of the plurality of intersecting yarns of the third layer attach to the first layer or the second layer at a location beyond the intersection of yarns.

28. The saddle pad of claim 27, wherein each of the plurality of intersecting yarns of the third layer attach to the first layer.

29. The saddle pad of claim 16, wherein the second layer is attached to the first layer between the plurality of intersecting yarns of the third layer.

30. A method for making a saddle pad, comprising:
weaving yarns to form a middle-layer;
placing the middle layer onto the second or bottom layer;
attaching the middle layer to the bottom layer;
placing the top layer onto the middle-layer; and
attaching the top layer to at least one of the middle layer and the bottom layer.
